(19) United States
(12) Patent Application Publication
(10) Pub. No.: US 2024/0073906 A1
(43) Pub. Date: Feb. 29, 2024

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN); Lan Chen, Beijing (CN)

(73) Assignee: NTT DOCOMO, INC., Tokyo (JP)

(21) Appl. No.: 18/261,361

(22) PCT Filed: Jan. 14, 2021
(86) PCT No.: PCT/JP2021/001088

§ 371 Date: Jul. 13, 2023

(51) Int. Cl. H04W 72/21; H04W 72/12; H04W 72/54

(52) U.S. Cl. CPC H04W 72/21; H04W 72/12; H04W 72/54

(57) ABSTRACT

A terminal according to one aspect of the present disclosure includes a control section that determines, on the basis of at least one of information related to configuration of per-transmission/reception point beam failure detection for a specific cell included in a cell group, information related to configuration of an uplink control channel resource corresponding to a scheduling request configured for the cell group, and information related to a spatial relation corresponding to the uplink control channel, at least one of a spatial relation and an uplink control channel resource used for transmission of the scheduling request, and a transmitting section that transmits the scheduling request.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

In existing LTE systems (LTE Rel. 8 to Rel. 15), radio link quality monitoring (radio link monitoring (RLM)) is performed. When Radio link failure (RLF) is detected by using the RLM, a user terminal (User Equipment (UE)) is requested to re-establish RRC (Radio Resource Control) connection.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), implementation of procedure for switching to another beam in response to detection of beam failure (which may be referred to as beam failure recovery (BFR) procedure, BFR, link recovery procedure, or the like) is under study.

In Rel-17 (or later versions) NR, it is also assumed that a terminal (UE) performs communication by using a plurality of transmission/reception points (TRPs)/UE panels. In this case, it is conceivable that beam management (for example, beam failure detection) is performed in the plurality of TRPs/plurality of UE panels, but how to control beam failure detection (BFD) or beam failure recovery (BFR) in each TRP/UE panel is an issue. Unless the beam failure detection or beam failure recovery in each TRP/UE panel can be controlled appropriately, communication throughput reduction or communication quality degradation may occur.

The present disclosure has been made in view of such points, and an object of the present disclosure is to provide a terminal, a radio communication method, and a base station that can appropriately perform beam failure detection or beam failure recovery even when a plurality of transmission/reception points are used.

### Solution to Problem

A terminal according to one aspect of the present disclosure includes a control section that determines, on the basis of at least one of information related to configuration of per-transmission/reception point beam failure detection for a specific cell included in a cell group, information related to configuration of an uplink control channel resource corresponding to a scheduling request configured for the cell group, and information related to a spatial relation corresponding to the uplink control channel, at least one of a spatial relation and an uplink control channel resource used for transmission of the scheduling request, and a transmitting section that transmits the scheduling request.

### Advantageous Effects of Invention

According to one aspect of the present disclosure, it is possible to appropriately perform beam failure detection or beam failure recovery even when a plurality of transmission/reception points are used.

### BRIEF DESCRIPTION OF DRAWINGS

FIG. 1 is a diagram to show an example of beam recovery procedure in Rel-15 NR.

FIG. 2A to FIG. 2C are each a diagram to show an example of configuration of a PUCCH resource for a scheduling request and configuration of a spatial relation.

FIG. 3A to FIG. 3C are each a diagram to show an example of BFR types applied to respective cells in a cell group according to a first aspect.

FIG. 4 is a diagram to show an example of SR transmission control according to the first aspect.

FIG. 5A and FIG. 5B are each a diagram to show another example of the BFR types applied to the respective cells in the cell group according to the first embodiment.

FIG. 6 is a diagram to show an example of SR transmission control according to the first aspect.

FIG. 7A and FIG. 7B are each a diagram to show an example of a case where a plurality of SRs according to a second aspect are configured.

FIG. 8 is a diagram to show an example of a schematic structure of a radio communication system according to one embodiment.

FIG. 9 is a diagram to show an example of a structure of a base station according to one embodiment.

FIG. 10 is a diagram to show an example of a structure of a user terminal according to one embodiment.

FIG. 11 is a diagram to show an example of a hardware structure of the base station and the user terminal according to one embodiment.

### DESCRIPTION OF EMBODIMENTS

### (Beam Failure Detection)

In NR, communication is performed by using beam forming. For example, a UE and a base station (for example, gNB (gNodeB)) may use a beam used for signal transmission (also referred to as a transmit beam, Tx beam, or the like) and a beam used for signal reception (also referred to as a receive beam, Rx beam, or the like).

Using the beam forming is susceptible to interference from an obstruction, and thus it is assumed that radio link quality deteriorates. Due to deterioration of the radio link quality, radio link failure (RLF) may occur frequently. Occurrence of the RLF requires reconnection of a cell, and thus frequent occurrence of the RLF causes deterioration of system throughput.

In NR, in order to suppress occurrence of the RLF, when quality of a specific beam deteriorates, procedure for switching to another beam (which may be referred to as beam recovery (BR), beam failure recovery (BFR), L1/L2 (Layer 1/Layer 2) beam recovery, or the like) is performed. Note that the BFR procedure may be simply referred to as BFR.

Note that beam failure (BF) in the present disclosure may be referred to as link failure.

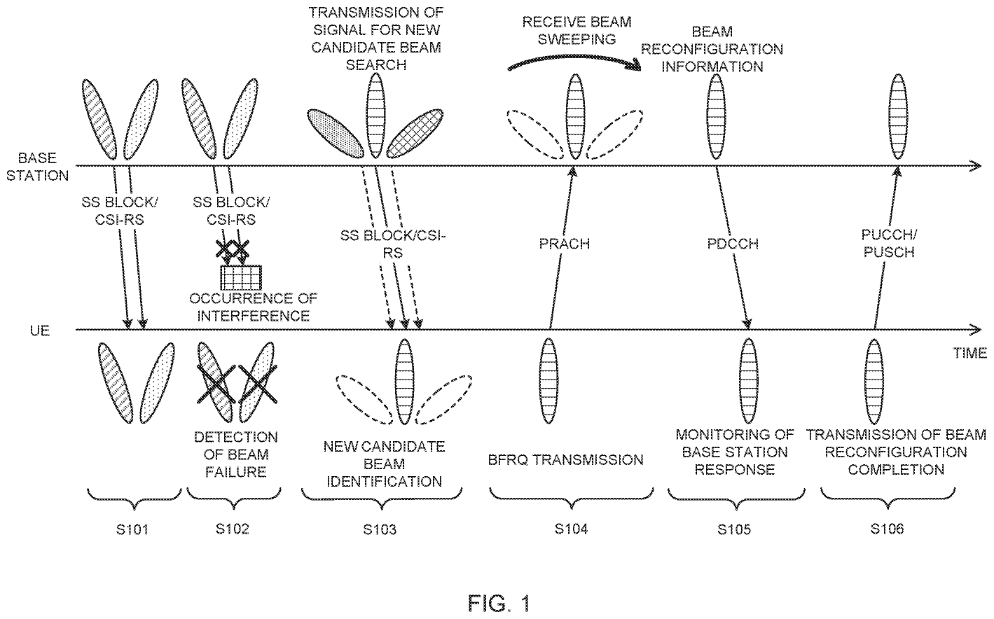

FIG. 1 is a diagram to show an example of the beam recovery procedure in Rel-15 NR. The number of beams and the like are just examples, and are not limited to this. In an initial state (step S101) of FIG. 1, the UE performs measurement based on a reference signal (RS) resource transmitted by using two beams.

The RS may be at least one of a synchronization signal block (SSB) and an RS for channel state measurement (Channel State Information RS (CSI-RS)). Note that the SSB may be referred to as an SS/PBCH (Physical Broadcast Channel) block or the like.

The RS may be at least one of a primary synchronization signal (Primary SS (PSS)), a secondary synchronization signal (Secondary SS (SSS)), a mobility reference signal (Mobility RS (MRS)), a signal included in the SSB, the SSB, the CSI-RS, a demodulation reference signal (DMRS), a beam-specific signal, and the like, or may be a signal constituted by expanding, changing, or the like these signals. The RS measured at step S101 may be referred to as an RS for beam failure detection (Beam Failure Detection RS (BFD-RS)), an RS used for beam recovery procedure (BFR-RS), or the like.

At step S102, due to interference of a radio wave from the base station, the UE fails to detect the BFD-RS (or quality of reception of the RS deteriorates). Such interference may occur due to, for example, influence of an obstruction, fading, interference, and the like between the UE and the base station.

The UE detects beam failure when a given condition is satisfied. For example, the UE may detect occurrence of the beam failure when a BLER (Block Error Rate) for all of configured BFD-RSs (BFD-RS resource configurations) is less than a threshold value. When occurrence of the beam failure is detected, a lower layer (physical (PHY) layer) of the UE may notify (indicate) a beam failure instance for a higher layer (MAC layer).

Note that judgment standards (criteria) are not limited to the BLER, and may be reference signal received power in the physical layer (Layer 1 Reference Signal Received Power (L1-RSRP)). In place of the RS measurement or in addition to the RS measurement, beam failure detection may be performed on the basis of a downlink control channel (Physical Downlink Control Channel (PDCCH)) or the like. The BFD-RS may be expected to be quasi-co-location (QCL) with a DMRS for a PDCCH monitored by the UE.

Here, QCL is an indicator indicating statistical properties of the channel. For example, when a given signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a UE receive beam (for example, a receive analog beam), and the beam may be identified on the basis of spatial QCL. The QCL (or at least one element in the relationship of QCL) in the present disclosure may be interpreted as sQCL (spatial QCL).

Information related to the BFD-RS (for example, indices, resources, numbers, the number of ports, precoding, and the like for the RS), information related to the beam failure detection (BFD) (for example, the above-mentioned threshold value), and the like may be configured (notified) for the UE by using higher layer signaling or the like. The information related to the BFD-RS may be referred to as information related to resources for BFR or the like.

In the present disclosure, the higher layer signaling may be, for example, any one or combinations of RRC (Radio Resource Control) signaling, MAC (Medium Access Control) signaling, broadcast information, and the like.

For example, the MAC signaling may use media access control control elements (MAC CEs (Control Elements)), MAC PDUs (Protocol Data Units), and the like. The broadcast information may be, for example, a master information block (MIB), a system information block (SIB), minimum system information (Remaining Minimum System Information (RMSI)), other system information (OSI), or the like.

The higher layer (for example, the MAC layer) of the UE may start a given timer (which may be referred to as a beam failure detection timer) when receiving beam failure instance notification from the PHY layer of the UE. The MAC layer of the UE may trigger BFR (for example, start any one of random access procedures mentioned below) when receiving the beam failure instance notification given times (for example, beamFailurelnstanceMaxCount configured by RRC) or more until the timer expires.

When there is no notification from the UE or when receiving a given signal (beam recovery request at step S104) from the UE, the base station may judge that the UE has detected beam failure.

At step S103, for beam recovery, the UE starts a search for a new candidate beam for use in new communication. The UE may select, by measuring a given RS, the new candidate beam corresponding to the RS. The RS measured at step S103 may be referred to as a new candidate RS, an RS for new candidate beam identification (New Candidate Beam Identification RS (NCBI-RS)), a CBI-RS, a CB-RS (Candidate Beam RS), or the like. The NCBI-RS may be the same as the BFD-RS, or may be different from the BFD-RS. Note that the new candidate beam may be simply referred to as a candidate beam or a candidate RS.

The UE may determine a beam corresponding to an RS satisfying a given condition as the new candidate beam. For example, the UE may determine the new candidate beam on the basis of an RS with L1-RSRP exceeding a threshold value, out of configured NCBI-RSs. Note that judgment standards (criteria) are not limited to the L1-RSRP. The L1-RSRP related to an SSB may be referred to as SS-RSRP. The L1-RSRP related to a CSI-RS may be referred to as CSI-RSRP.

Information related to the NCBI-RS (for example, resources, numbers, the number of ports, precoding, and the like for the RS), information related to new candidate beam identification (NCBI) (for example, the above-mentioned threshold value), and the like may be configured (notified) for the UE by using higher layer signaling or the like. Information related to the new candidate RS (or the NCBI-RS) may be obtained on the basis of information related to the BFD-RS. The information related to the NCBI-RS may be referred to as information related to an NBCI resource or the like.

Note that the BFD-RS, the NCBI-RS, and the like may be interpreted as a radio link monitoring reference signal (Radio Link Monitoring RS (RLM-RS)).

At step S104, the UE that has identified the new candidate beam transmits a beam recovery request (Beam Failure Recovery reQuest (BFRQ)). The beam recovery request may be referred to as a beam recovery request signal, a beam failure recovery request signal, or the like.

The BFRQ may be transmitted by using, for example, at least one of an uplink control channel (Physical Uplink Control Channel (PUCCH)), a random access channel (Physical Random Access Channel (PRACH)), an uplink shared channel (Physical Uplink Shared Channel (PUSCH)), and a configured grant (CG) PUSCH.

The BFRQ may include information about the new candidate beam/new candidate RS identified at step S103. A resource for the BFRQ may be associated with the new candidate beam. The information about the beam may be notified by using a beam index (BI), a port index of a given reference signal, an RS index, a resource index (for example, a CSI-RS resource indicator (CRI)), an SSB resource indicator (SSBRI), or the like.

For Rel-15 NR, CB-BFR (Contention-Based BFR) that is BFR based on contention-based random access (PA) procedure and CF-BFR (Contention-Free BFR) that is BFR based on non-contention-based random access procedure are under study. In the CB-BFR and the CF-BFR, the UE may transmit a preamble (also referred to as an RA preamble, a random access channel (Physical Random Access Channel (PRACH)), a RACH preamble, or the like) as the BFRQ by using a PRACH resource.

In the CB-BFR, the UE may transmit a preamble randomly selected from one or a plurality of preambles. On the other hand, in the CF-BFR, the UE may transmit a preamble allocated from the base station in a UE-specific manner. In the CB-BFR, the base station may allocate an identical preamble to a plurality of UEs. In the CF-BFR, the base station may allocate a preamble in a UE-dedicated manner.

Note that the CB-BFR and the CF-BFR may be referred to as CB PRACH-based BFR (contention-based PRACH-based BFR (CBRA-BFR)) and CF PRACH-based BFR (contention-free PRACH-based BFR (CFRA-BFR)), respectively. The CBRA-BFR may be referred to as CBRA for BFR. The CFRA-BFR may be referred to as CFRA for BFR.

In both of the CB-BFR and the CF-BFR, information related to the PRACH resource (PA preamble) may be notified by using, for example, higher layer signaling (RRC signaling or the like). For example, the information may include information indicating correspondence between detected DL-RSs (beams) and PRACH resources, and a different PRACH resource may be associated with each DL-RS.

At step S105, the base station that has detected the BFRQ transmits a response signal (which may be referred to as gNB response or the like) in response to the BFRQ from the UE. The response signal may include reconfiguration information about one or a plurality of beams (for example, DL-RS resource configuration information).

The response signal may be transmitted in, for example, a UE-common search space of a PDCCH. The response signal may be notified by using a PDCCH (DCI) cyclic redundancy check (CRC)-scrambled by a UE identifier (for example, a cell-radio RNTI (C-RNTI)). The UE may judge, on the basis of beam reconfiguration information, at least one of a transmit beam and a receive beam to be used.

The UE may monitor the response signal on the basis of at least one of a control resource set (CORESET) for BFR and a search space set for BFR.

With respect to the CB-BFR, when the UE receives a PDCCH corresponding to a C-RNTI related to the UE itself, it may be judged that contention resolution has succeeded.

With respect to processing at step S105, a period for the UE to monitor response from the base station (for example, gNB) to the BFRQ may be configured. The period may be referred to as, for example, a gNB response window, a gNB window, a beam recovery request response window, or the like. The UE may perform retransmission of the BFRQ when there is no gNB response detected in the window period.

At step S106, the UE may transmit, to the base station, a message indicating that beam reconfiguration has been completed. For example, the message may be transmitted on a PUCCH, or may be transmitted on a PUSCH.

Beam recovery success (BR success) may represent, for example, a case where step S106 has been reached. On the other hand, beam recovery failure (BR failure) may correspond to, for example, a case that BFRQ transmission has reached a given number of times or a case that a beam failure recovery timer (Beam-failure-recovery-Timer) has expired.

In Rel. 15, a case that beam recovery procedure (for example, BFRQ notification) for beam failure detected in an SpCell (PCell/PSCell) is performed by using random access procedure is supported.

On the other hand, in Rel. 16, a case that beam recovery procedure (for example, BFRQ notification (step S104 in FIG. 1)) for beam failure detected in an SCell is performed by using at least one of PUCCH (for example, scheduling request (SR)) transmission for BFR and MAC CE (for example, UL-SCH) transmission for BFR is supported. For example, the UE may transmit information related to beam failure by using two MAC CE-based steps. The information related to the beam failure may include information related to a cell in which the beam failure has been detected and information related to a new candidate beam (or a new candidate RS index).

### [Step 1]

When BF has been detected, a PUCCH-BFR (scheduling request (SR)) may be transmitted from the UE to the SpCell (for example, the PCell/PSCell). The PUCCH-BFR may be referred to as a PUCCH-SR, a BFR PUCCH-SR, or an SR PUCCH.

Subsequently, a UL grant (for example, DCI) for step 2 described below may be transmitted from the PCell/PSCell to the UE. In a case where beam failure has been detected, when a MAC CE (or a UL-SCH) for transmitting information related to a new candidate beam is present, step 1 (for example, PUCCH transmission) may be omitted to perform step 2 (for example, MAC CE transmission).

### [Step 2]

The UE may transmit, to the base station (PCell/PSCell), information (for example, cell index) related to a (unsuccessful) cell in which the beam failure has been detected and the information related to the new candidate beam by using the MAC CE via an uplink channel (for example, a PUSCH). After that, after BFR procedure, QCL of a PDCCH/PUCCH/PDSCH/PUSCH may be updated to a new beam after a given period (for example, 28 symbols) from reception of a response signal from the base station.

Note that these step numbers are just numbers for description, and a plurality of steps may be combined with each other, or the order of the steps may be changed. Whether to perform the BFR may be configured for the UE by using higher layer signaling.

Incidentally, for future radio communication systems (for example, Rel. 17 (or later versions)), enhancement of beam management by a UE having a plurality of panels (multi-panel) or beam management using a plurality of transmission/reception points (multiple Transmission/Reception Points (TRPs)) is under study.

In beam failure detection/beam failure recovery in Rel. 17 (or later versions), it is assumed that a BFRQ framework based on an SCell BFR BFRQ in Rel. 16 is supported. In this case, up to X PUCCH-SR resources (for example, dedicated PUCCH-SR resources) may be configured in a cell group. X may be 1, may be 2, or may be 2 or more.

In the present disclosure, the cell group may be, for example, at least one of a master cell group (MCG), a secondary cell group (SCG), and a PUCCH cell group. The MCG and the SCG may be groups configured in dual connectivity (DC). The PUCCH cell group may be a group configured in PUCCH transmission.

In Rel. 17 (or later versions), it is conceivable that beam failure detection/beam failure recovery (for example, per-TRP BFR) is performed for each plurality of TRPs/plurality of UE panels in a given cell. For example, it is also conceivable that scheduling request (SR) transmission is supported for BFR for each TRP/in units of a TRP.

In this case, how to control scheduling request configuration (for example, SR configuration) becomes an issue. For example, how to control configuration of an SR (for example, an SR index/SchedulingRequestID), configuration of a PUCCH resource (for example, a PUCCH-SR resource), and configuration of a spatial relation corresponding to a PUCCH resource (for example, spatial relation) for a cell group (or a cell/TRP) becomes an issue. Alternatively, how to control transmission of an SR for BFR (or a PUCCH-SR) on the basis of a BFR type configured for/applied to each cell included in the cell group (for example, whether per-TRP BFR is configured/applied) becomes an issue.

The inventors of the present invention focused on a case where beam failure recovery procedure (UE operation based on beam failure detection/beam failure recovery request/beam failure recovery) is applied in units of one or more TRPs/panels, studied an SR configuration/SR transmission method in such a case, and came up with the idea of the present embodiment.

Embodiments according to the present disclosure will be described in detail with reference to the drawings as follows. Respective aspects may each be employed individually, or may be employed in combination.

In the present disclosure, the UE may be a UE that performs transmission/reception to/from a TRP by using a plurality of panels. Each panel may correspond to a different TRP, one panel may correspond to a plurality of TRPs, or the plurality of panels may correspond to one TRP.

In the present disclosure, a panel (or a panel index) of the UE may correspond to a specific group. In this case, the UE may assume that a beam/RS of each group is measured in each panel of the UE. The UE may assume that beams of a plurality of groups are received simultaneously (by using different panels).

In the present disclosure, a TRP and each of a panel of the TRP (or base station), an RS group, an antenna port group, a spatial relation group, a QCL group, a TCI state, a TCI state group, a CORESET group, a CORESET pool, and the like may be interchangeably interpreted. Also, a TRP index and each of an RS group index, an antenna port group index, a QCL group index, a TCI state index, a TCI state group index, a CORESET group index, a CORESET pool index, and the like may be interchangeably interpreted.

In the present disclosure, a panel of the UE and each of an RS group, an antenna port group, a spatial relation group, a QCL group, a TCI state group, a CORESET group, and the like may be interchangeably interpreted.

In the present disclosure, the panel may be associated with a group index of an SSB/CSI-RS group. In the present disclosure, the panel may be associated with a TRP. In the present disclosure, the plurality of panels may be associated with a group index of group beam-based reporting. In the present disclosure, the panel may be associated with a group index of an SSB/CSI-RS group for group beam-based reporting.

In the present disclosure, a serving cell/cell may be interpreted as a PCell, a PSCell, an SpCell, or an SCell. Descriptions below use, as an example, a case where two TRPs correspond to a serving cell, but three or more TRPs may correspond to the serving cell.

In the present disclosure, a BFD RS with which beam failure has been detected, a failed BFD RS, a TRP in which beam failure has been detected, a failed TRP, a UE panel with detection of beam failure, and a failed UE panel may be interchangeably interpreted.

In the present disclosure, “A/B” may be interpreted as “at least one of A and B” or “A and B.” In the present disclosure, “A/B/C” may be interpreted as “at least one of A, B, and C.”

### (Example of SR Configuration)

For SR configuration, at least one of option 0, option 1, and option 2 below may be supported.

### <Option 0>

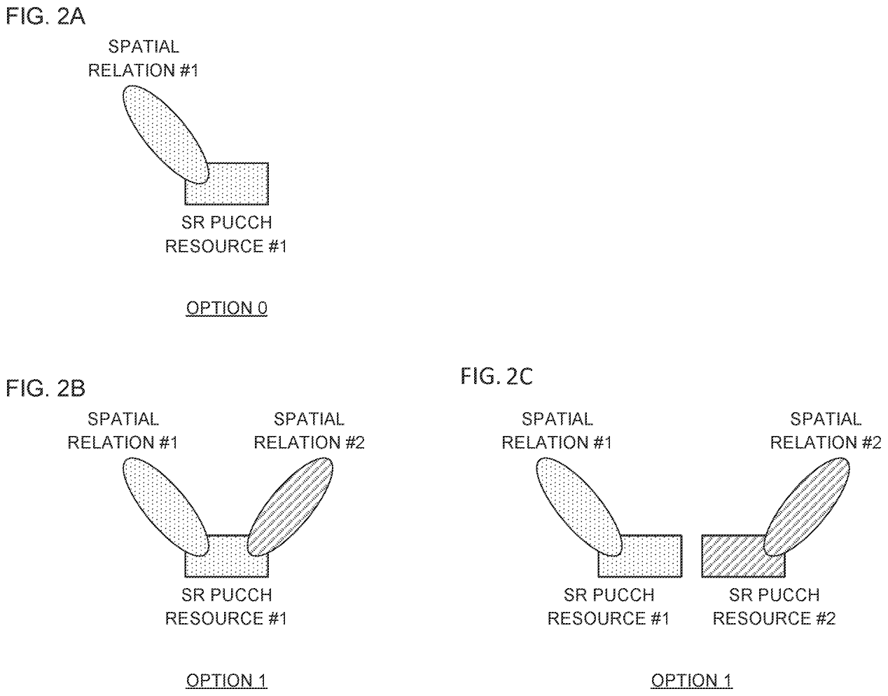

X₀ PUCCH resources (or SR PUCCHs) are configured for an SR (for example, an SR index/SchedulingRequestID) in a cell group, and Y₀ spatial relations are configured for the PUCCH resources. In descriptions below, assume X₀=1, Y₀=1 (see FIG. 2A).

FIG. 2A shows a case where one SR PUCCH resource (here, SR PUCCH resource #1) is configured for an SR configured in a cell group (or an SpCell), and where one spatial relation (here, spatial relation #1) is configured for the SR PUCCH resource. Note that numbers of X₀ and Y₀ are not limited to this.

An SR configuration method for SCell BFR in Rel. 16 may be employed in option 0. Option 0 may be interpreted as a 0-th SR/0-th SR configuration.

### <Option 1>

Up to X₁ PUCCH resources (for example, dedicated PUCCH-SR resources) in a cell group are configured for an SR (for example, an SR index/SchedulingRequestID) for each cell group, and Y₁ spatial relations are configured for the PUCCH resources. In descriptions below, assume X₁=1, Y₁=2 (see FIG. 2B).

FIG. 2B shows a case where one SR PUCCH resource (here, SR PUCCH resource #1) is configured for an SR configured in a cell group (or an SpCell), and where two spatial relations (here, spatial relation #1 and spatial relation #2) are configured for the SR PUCCH resource. Note that numbers of X₁ and Y₁ are not limited to this. Option 1 may be interpreted as a first SR/first SR configuration.

### <Option 2>

Up to X₂ PUCCH resources (for example, dedicated PUCCH-SR resources) in a cell group are configured for an SR (for example, an SR index/SchedulingRequestID) for each cell group, and Y₂ spatial relations are configured for each PUCCH resource. In descriptions below, assume X₂=2 (or two or more), Y₂=1 (see FIG. 2C).

FIG. 2C shows a case where two SR PUCCH resources (here, SR PUCCH resource #1 and SR PUCCH resource #2) are configured for an SR configured in a cell group (or an SpCell), and where one spatial relation is configured for each SR PUCCH resource (here, spatial relation #1 and spatial relation #2). FIG. 2C shows a case where different spatial relations are configured for SR PUCCH resource #1 and SR PUCCH resource #2, but the same spatial relation may be configured. Note that numbers of X₂ and Y₂ are not limited to this. Option 2 may be interpreted as a second SR/second SR configuration.

The UE may receive, from a network (for example, a base station) by using higher layer signaling/DCI, at least one of information related to an SR (for example, an SR index/SchedulingRequestID) in a cell group, information related to a PUCCH resource (for example, a PUCCH-SR resource) in the cell group, and information related to a spatial relation (for example, spatial relation) configured for the PUCCH resource.

The information related to the SR may be at least one of information indicating an SR index (or SchedulingRequestID) to be configured and information indicating the number of SRs to be configured. The information related to the PUCCH resource in the cell group may be at least one of information indicating a PUCCH resource and information indicating the number of PUCCH resources to be configured. The information related to the spatial relation may be at least one of information indicating a spatial relation and information indicating the number of spatial relations to be configured. In the present disclosure, a spatial relation (for example, spatial relation), a beam, a spatial filter, a spatial domain filter, a TCI state, and QCL may be interchangeably interpreted.

For each cell (for example, a cell included in a cell group), the UE may receive information related to configuration of BFR for each BFR/in units of BFR from the network (for example, the base station) by using higher layer signaling/DCI. The information related to the configuration of BFR for each BFR/in units of BFR may be information indicating the presence or absence of configuration/application of BFR for each BFR/in units of BFR. Alternatively, the information related to the configuration of BFR for each BFR/in units of BFR may be information indicating a BFR type (BFR for each BFR/in units of BFR or cell-specific BFR).

The UE may control transmission of an SR or a PUCCH-SR on the basis of at least one of the number of SRs (or the number of SR indices) configured for each cell group and a BFR type (for example, per-TRP BFR/per-cell BFR) configured for/applied to a specific cell included in a cell group. In this case, the UE may control transmission of an SR or a PUCCH-SR on the basis of at least one of the number of PUCCH resources to be configured and the number of spatial relations configured for (or corresponding to) a PUCCH resource.

### (First Aspect)

In a first aspect, a case where up to one SR (or SR index) is configurable (or only one SR (or SR index) is configured) for each cell group in BFR will be described. The BFR may include SCell BFR in Rel. 16/per-TRP BFR in Rel. 17. In descriptions below, a PUCCH may be interpreted as an SR PUCCH, and a PUCCH resource may be interpreted as a PUCCH-SR resource. Per-TRP BFR may be interpreted as BFR in units of a TRP. Cell-specific BFR may be interpreted as BFR in units of a cell.

### <Case A>

In a cell group, assume a case where per-TRP BFR is configured for at least a specific cell or a case where a specific cell for which per-TRP BFR is supported is configured. In this case, BFR (for example, per-TRP BFR) procedure for each TRP may be employed in the specific cell.

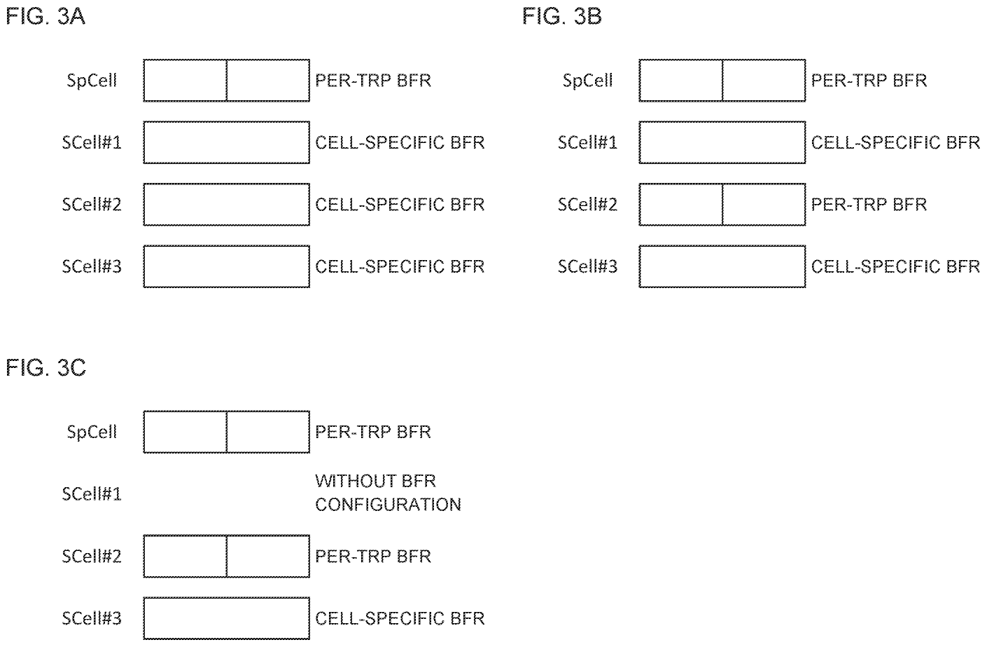

The specific cell may be an SpCell (for example, a PCell/PSCell). In this case, a cell group including the SpCell may include, for example, the SpCell and one or more SCells (see FIG. 3A to FIG. 3C). In case A, at least the SpCell may support BFR for each TRP, and some or all of other SCells may support BFR for each TRP, or may not support BFR for each TRP.

For example, as shown in FIG. 3A, per-TRP BFR may be configured for/applied to the SpCell, and cell-specific BFR may be configured for/applied to the other SCells (here, SCell #1 to SCell #3). Alternatively, as shown in FIG. 3B, per-TRP BFR may be configured for/applied to the SpCell, per-TRP BFR may be configured for/applied to some of the SCells (here, SCell #2), and cell-specific BFR may be configured for/applied to the remaining SCells (here, SCell #1 and SCell #3). Alternatively, as shown in FIG. 3C, BFR itself may not be configured for some of the SCells (here, SCell #1).

As configuration of a BFR SR for the cell group, at least one of option 1 and option 2 described above may be employed. In other words, two beams/spatial relations may be configured for one PUCCH (or PUCCH resource) (option 1 described above/see FIG. 2B), or two beams/spatial relations may be configured for two PUCCHs (or PUCCH resources) (option 2 described above/see FIG. 2C).

### <<Beam Failure in SpCell>>

When a plurality of TRPs (for example, TRP #0 and TRP #1) are included in the SpCell, and beam failure (for example, TRP failure) is detected in some TRPs (for example, TRP #0) of the plurality of TRPs, the SR may be triggered.

Case A1

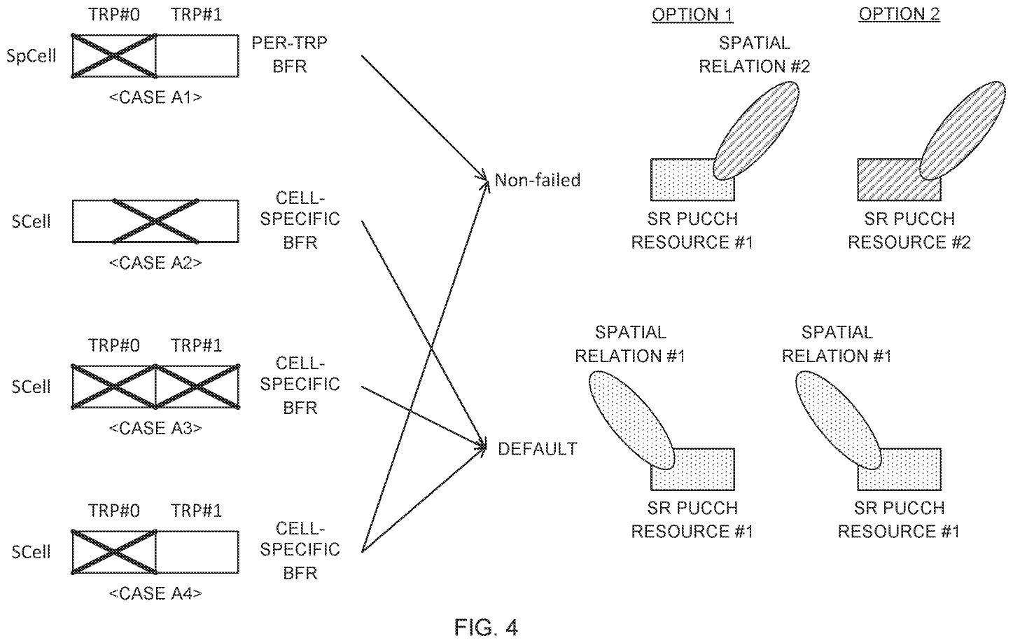

Assume a case where one PUCCH resource has been configured for the cell group/SR, two spatial relations have been configured for the PUCCH resource (option 1 described above), and beam failure has been detected in TRP #0 (or a case where the SR has been triggered on the basis of beam failure in TRP #0). In this case, a UE may transmit the SR by using a spatial relation (here, spatial relation #2) associated with another TRP (for example, TRP #1) (case A1 of FIG. 4/see option 1).

Therefore, the UE can transmit the SR by using a spatial relation without detection of beam failure (or with higher quality).

Alternatively, assume a case where two PUCCH resources have been configured for the cell group/SR, one spatial relation has been configured for each PUCCH resource (option 2 described above), and beam failure has been detected in TRP #0 (or a case where the SR has been triggered on the basis of beam failure in TRP #0). In this case, the UE may transmit the SR by using an SR PUCCH/SR PUCCH resource (here, SR PUCCH resource #2) associated with another TRP (for example, TRP #1) (case A1 of FIG. 4/see option 2).

Therefore, the UE can transmit the SR by using a PUCCH resource without detection of beam failure (or with higher quality).

### <<Beam Failure in SCell>>

### [Without BFR Configuration for Each TRP]

When BFR operation for each TRP is not configured for an SCell, cell-specific BFR may be applied in the SCell. When beam failure (for example, TRP failure) is detected in the SCell, the SR may be triggered. The SR may be transmitted by a PUCCH (for example, a PUCCH-SR) in an SpCell included in a cell group to which the SCell belongs.

Case A2

Assume a case where one PUCCH resource has been configured for the cell group/SR, two spatial relations have been configured for the PUCCH resource (option 1 described above), and beam failure has been detected in the SCell (or a case where the SR has been triggered on the basis of beam failure in the SCell). In this case, the UE may transmit a default beam/default spatial relation for the SR (or transmit the SR by using a default beam/default spatial relation) (case A2 of FIG. 4/see option 1).

Alternatively, assume a case where two PUCCH resources have been configured for the cell group/SR, one spatial relation has been configured for each PUCCH resource (option 2 described above), and beam failure has been detected in the SCell (or a case where the SR has been triggered on the basis of beam failure in the SCell). In this case, the UE may transmit a default PUCCH/default PUCCH resource for the SR (or transmit the SR by using a default PUCCH/default PUCCH resource) (case A2 of FIG. 4/see option 2).

Thus, when beam failure has been detected in an SCell, the UE may control SR transmission by using a default spatial relation (option 1) or a default PUCCH resource (option 2). Therefore, it is possible to appropriately control SR transmission even when a plurality of spatial relations/PUCCH resources for SR transmission are configured.

In option 1, the default beam/default spatial relation for the SR may be predefined in specifications, may be determined on the basis of a given rule (for example, order of spatial relation indices or the like), or may be configured for the UE by higher layer signaling or the like from the base station. For example, the default beam/default spatial relation for the SR may be the first spatial relation for the SR (for example, 1st spatial relation), or may be a spatial relation for the SR associated with the lowest spatial relation index (for example, lowest spatial relation ID) or the lowest control resource set index (for example, lowest CORESETPoolIndex) for the SR.

In option 2, the default PUCCH/default PUCCH resource for the SR may be predefined in specifications, may be determined on the basis of a given rule (for example, order of PUCCH resource indices or the like), or may be configured for the UE by higher layer signaling or the like from the base station. For example, the default PUCCH/default PUCCH resource for the SR may be the first PUCCH resource for the SR (for example, 1st PUCCH resource), or may be a PUCCH resource for the SR associated with the lowest PUCCH resource (for example, lowest PUCCH resource ID) or the lowest control resource set index (for example, lowest CORESETPoolIndex) for the SR.

### [With BFR Configuration for Each TRP]

When BFR operation for each TRP is configured for an SCell, BFR (for example, per-TRP BFR) procedure for each TRP may be applied in the SCell.

When a plurality of TRPs (for example, TRP #0 and TRP #1) are included in the SCell, and beam failure (for example, TRP failure) is detected in some TRPs (for example, TRP #0) of the plurality of TRPs, the SR may be triggered.

Case A3

Assume a case where one PUCCH resource has been configured for the cell group/SR, two spatial relations have been configured for the PUCCH resource (option 1 described above), and beam failure has been detected in all TRPs (for example, TRP #0 and TRP #1) (or a case where the SR has been triggered on the basis of beam failure in two TRPs). In this case, the UE may transmit a default beam/default spatial relation for the SR (or transmit the SR by using a default beam/default spatial relation) (case A3 of FIG. 4/see option 1).

Alternatively, assume a case where two PUCCH resources have been configured for the cell group/SR, one spatial relation has been configured for each PUCCH resource (option 2 described above), and beam failure has been detected in all TRPs (for example, TRP #0 and TRP #1) (or a case where the SR has been triggered on the basis of beam failure in two TRPs). In this case, the UE may transmit a default PUCCH/default PUCCH resource for the SR (or transmit the SR by using a default PUCCH/default PUCCH resource) (case A3 of FIG. 4/option 2).

Thus, when beam failure has been detected in a plurality of TRPs (for example, all TRPs) in an SCell, the UE may control SR transmission by using a default spatial relation (option 1) or a default PUCCH resource (option 2). Therefore, it is possible to appropriately control SR transmission even when a plurality of spatial relations/PUCCH resources for SR transmission are configured.

Case A4

Alternatively, assume a case where one PUCCH resource has been configured for the cell group/SR, two spatial relations have been configured for the PUCCH resource (option 1 described above), and beam failure has been detected in TRP #0 (or a case where the SR has been triggered on the basis of beam failure in TRP #0). In this case, the UE may transmit a default beam/default spatial relation for the SR (or transmit the SR by using a default beam/default spatial relation) (case A4 of FIG. 4/see option 1). Alternatively, the UE may transmit the SR by using a spatial relation (Non-failed) associated with another TRP (for example, TRP #1) (case A4 of FIG. 4/see option 1).

Alternatively, assume a case where two PUCCH resources have been configured for the cell group/SR, one spatial relation has been configured for each PUCCH resource (option 2 described above), and beam failure has been detected in TRP #0 (or a case where the SR has been triggered on the basis of beam failure in TRP #0). In this case, the UE may transmit a default PUCCH/default PUCCH resource for the SR (or transmit the SR by using a default PUCCH/default PUCCH resource) (case A4 of FIG. 4/see option 2). Alternatively, the UE may transmit the SR by using an SR PUCCH/SR PUCCH resource (Non-failed) associated with another TRP (for example, TRP #1) (case A4 of FIG. 4/see option 2).

### <Case B>

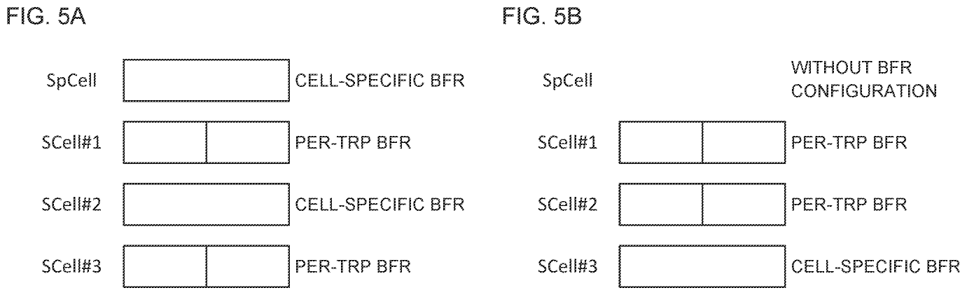

In a cell group, assume a case where BFR operation for each TRP is not configured (or BFR itself is not configured) for a specific cell (for example, an SpCell), and where BFR operation for each TRP is configured for at least another cell (for example, an SCell) (see FIG. 5A and FIG. 5B). In this case, BFR (for example, per-TRP BFR) procedure for each TRP may be applied in the SCell, and cell-specific BFR may be applied in the SpCell.

For example, as shown in FIG. 5A, cell-specific BFR may be configured for/applied to the SpCell, per-TRP BFR may be configured for/applied to some SCells (here, SCell #1 and SCell #3), and cell-specific BFR may be configured for/applied to the remaining SCell (here, SCell #2). Alternatively, as shown in FIG. 5B, BFR itself may not be configured for the SpCell.

As configuration of a BFR SR for the cell group, option 0 described above (see FIG. 2A) may be employed (Alt. 1). Specifically, one PUCCH resource may be configured for the SR for the cell group, and one spatial relation may be configured for the PUCCH resource (that is, one beam/spatial relation may be configured for one PUCCH/PUCCH resource).

Per-TRP BFR is not configured/supported for the SpCell, and thus when the SR is triggered in response to detection of beam failure in the SCell, the SR can be appropriately transmitted in the SpCell as long as the SpCell is not detected as beam failure.

Alternatively, as configuration of a BFR SR for the cell group, at least one of option 1 and option 2 described above may be employed (Alt. 2). In other words, two beams/spatial relations may be configured for one PUCCH (or PUCCH resource) (option 1), or two beams/spatial relations may be configured for two PUCCHs (or PUCCH resources) (option 2).

### <<Beam Failure in SpCell>>

When BFR operation for each TRP is not configured for an SpCell, cell-specific BFR may be applied in the SpCell. When beam failure (for example, TRP failure) is detected in the SpCell, the SR may be triggered.

Assume a case where one PUCCH resource has been configured for the cell group/SR, two spatial relations have been configured for the PUCCH resource (option 1 described above), and beam failure has been detected in the SpCell (or a case where the SR has been triggered on the basis of beam failure in the SpCell). In this case, the UE may transmit a default beam/default spatial relation for the SR (or transmit the SR by using a default beam/default spatial relation).

Alternatively, assume a case where two PUCCH resources have been configured for the cell group/SR, one spatial relation has been configured for each PUCCH resource (option 2 described above), and beam failure has been detected in the SpCell (or a case where the SR has been triggered on the basis of beam failure in the SpCell). In this case, the UE may transmit a default PUCCH/default PUCCH resource for the SR (or transmit the SR by using a default PUCCH/default PUCCH resource).

Thus, when beam failure has been detected in an SpCell for which BFR operation for each TRP is not configured, the UE may control SR transmission by using a default spatial relation (option 1) or a default PUCCH resource (option 2). Therefore, it is possible to appropriately control SR transmission even when a plurality of spatial relations/PUCCH resources for SR transmission are configured.

Alternatively, in a case where BFR operation for each TRP is not configured for an SpCell, when beam failure has been detected in the SpCell, BFR procedure using a PRACH (for example, BFR procedure in Rel. 15) may be employed.

### <<Beam Failure in SCell>>

### [Without BFR Configuration for Each TRP]

When BFR operation for each TRP is not configured for an SCell, cell-specific BFR may be applied in the SCell. When beam failure (for example, TRP failure) is detected in the SCell, the SR may be triggered. The SR may be transmitted by a PUCCH (for example, a PUCCH-SR) in an SpCell included in a cell group to which the SCell belongs.

Case B1

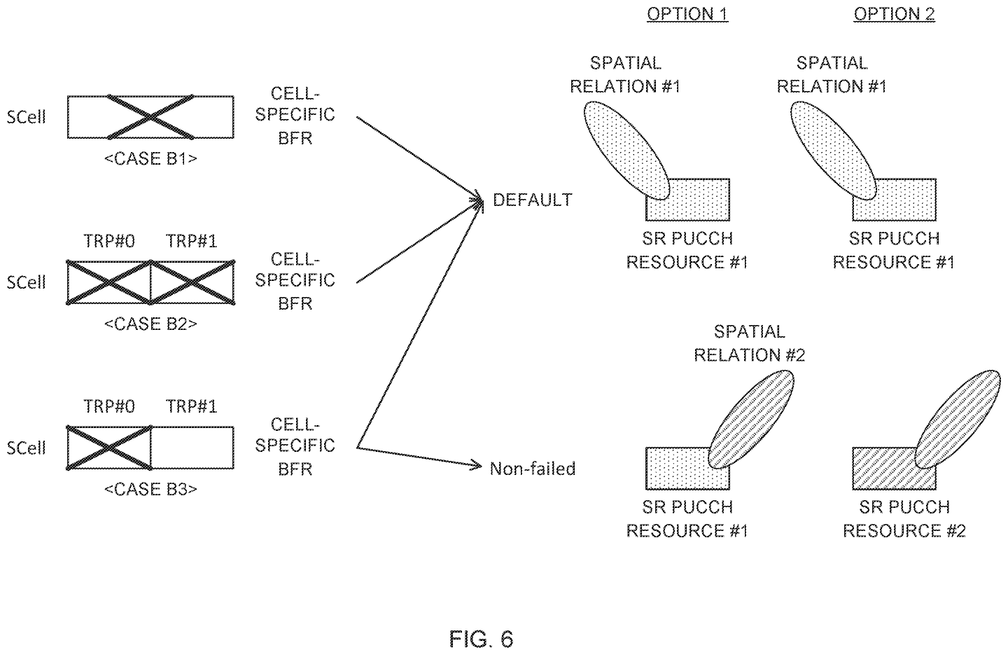

Assume a case where one PUCCH resource has been configured for the cell group/SR, two spatial relations have been configured for the PUCCH resource (option 1 described above), and beam failure has been detected in the SCell (or a case where the SR has been triggered on the basis of beam failure in the SCell). In this case, the UE may transmit a default beam/default spatial relation for the SR (or transmit the SR by using a default beam/default spatial relation) (case B1 of FIG. 6/see option 1).

Alternatively, assume a case where two PUCCH resources have been configured for the cell group/SR, one spatial relation has been configured for each PUCCH resource (option 2 described above), and beam failure has been detected in the SCell (or a case where the SR has been triggered on the basis of beam failure in the SCell). In this case, the UE may transmit a default PUCCH/default PUCCH resource for the SR (or transmit the SR by using a default PUCCH/default PUCCH resource) (case B1 of FIG. 6/see option 2).

Thus, when beam failure has been detected in an SCell, the UE may control SR transmission by using a default spatial relation (option 1) or a default PUCCH resource (option 2). Therefore, it is possible to appropriately control SR transmission even when a plurality of spatial relations/PUCCH resources for SR transmission are configured.

In option 1, the default beam/default spatial relation for the SR may be predefined in specifications, may be determined on the basis of a given rule (for example, order of spatial relation indices or the like), or may be configured for the UE by higher layer signaling or the like from the base station. For example, the default beam/default spatial relation for the SR may be the first spatial relation for the SR (for example, 1st spatial relation), or may be a spatial relation for the SR associated with the lowest spatial relation index (for example, lowest spatial relation ID) or the lowest control resource set index (for example, lowest CORESETPoolIndex) for the SR.

In option 2, the default PUCCH/default PUCCH resource for the SR may be predefined in specifications, may be determined on the basis of a given rule (for example, order of PUCCH resource indices or the like), or may be configured for the UE by higher layer signaling or the like from the base station. For example, the default PUCCH/default PUCCH resource for the SR may be the first PUCCH resource for the SR (for example, 1st PUCCH resource), or may be a PUCCH resource for the SR associated with the lowest PUCCH resource (for example, lowest PUCCH resource ID) or the lowest control resource set index (for example, lowest CORESETPoolIndex) for the SR.

### [With BFR Configuration for Each TRP]

When BFR operation for each TRP is configured for an SCell, BFR (for example, per-TRP BFR) procedure for each TRP may be applied in the SCell.

When a plurality of TRPs (for example, TRP #0 and TRP #1) are included in the SCell, and beam failure (for example, TRP failure) is detected in at least some TRPs (for example, TRP #0) of the plurality of TRPs, the SR may be triggered.

Case B2

Assume a case where one PUCCH resource has been configured for the cell group/SR, two spatial relations have been configured for the PUCCH resource (option 1 described above), and beam failure has been detected in all TRPs (for example, TRP #0 and TRP #1) (or a case where the SR has been triggered on the basis of beam failure in two TRPs). In this case, the UE may transmit a default beam/default spatial relation for the SR (or transmit the SR by using a default beam/default spatial relation) (case B2 of FIG. 6/see option 1).

Alternatively, assume a case where two PUCCH resources have been configured for the cell group/SR, one spatial relation has been configured for each PUCCH resource (option 2 described above), and beam failure has been detected in all TRPs (for example, TRP #0 and TRP #1) (or a case where the SR has been triggered on the basis of beam failure in two TRPs). In this case, the UE may transmit a default PUCCH/default PUCCH resource for the SR (or transmit the SR by using a default PUCCH/default PUCCH resource) (case B2 of FIG. 6/see option 2).

Thus, when beam failure has been detected in a plurality of TRPs (for example, all TRPs) in an SCell, the UE may control SR transmission by using a default spatial relation (option 1) or a default PUCCH resource (option 2). Therefore, it is possible to appropriately control SR transmission even when a plurality of spatial relations/PUCCH resources for SR transmission are configured.

Case B3

Alternatively, assume a case where one PUCCH resource has been configured for the cell group/SR, two spatial relations have been configured for the PUCCH resource (option 1 described above), and beam failure has been detected in TRP #0 (or a case where the SR has been triggered on the basis of beam failure in TRP #0). In this case, the UE may transmit a default beam/default spatial relation for the SR (or transmit the SR by using a default beam/default spatial relation) (case B3 of FIG. 6/see option 1). Alternatively, the UE may transmit the SR by using a spatial relation (Non-failed) associated with another TRP (for example, TRP #1) (case B3 of FIG. 6/see option 1).

Alternatively, assume a case where two PUCCH resources have been configured for the cell group/SR, one spatial relation has been configured for each PUCCH resource (option 2 described above), and beam failure has been detected in TRP #0 (or a case where the SR has been triggered on the basis of beam failure in TRP #0). In this case, the UE may transmit a default PUCCH/default PUCCH resource for the SR (or transmit the SR by using a default PUCCH/default PUCCH resource) (case B3 of FIG. 6/see option 2). Alternatively, the UE may transmit the SR by using an SR PUCCH/SR PUCCH resource (Non-failed) associated with another TRP (for example, TRP #1) (case B3 of FIG. 6/see option 2).

### (Second Aspect)

In a second aspect, a case where a plurality of SRs or up to N SRs (for example, N=2) are configurable for each cell group in BFR will be described. Descriptions below use N=2 as an example, but the number of SRs configurable for the cell group is not limited to 2.

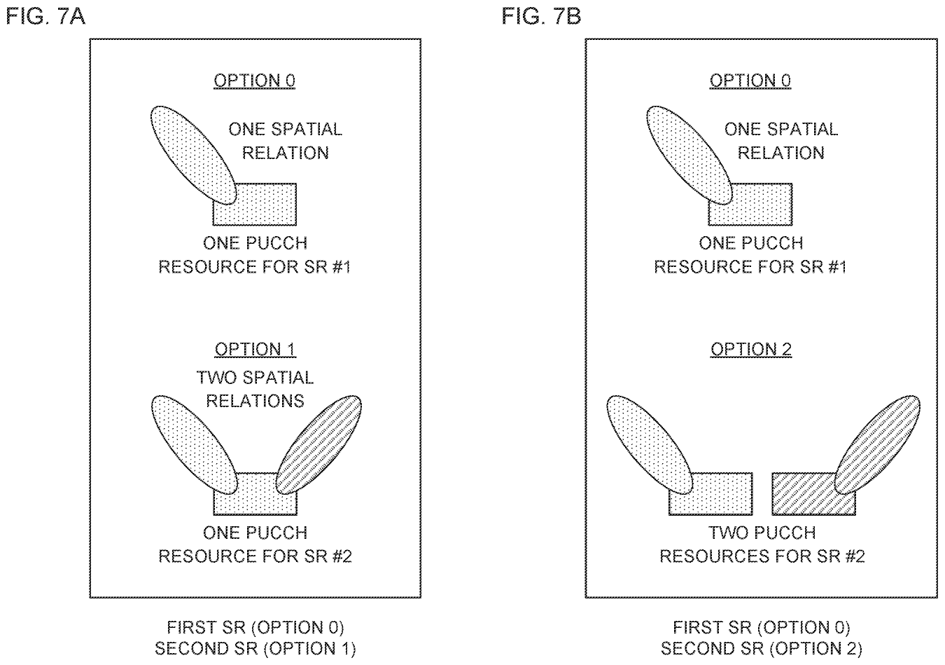

For example, two SR configurations with consideration of different conditions for each cell group may be configured. As two SRs (or SR configuration corresponding to two SRs), an SR (for example, a first SR) corresponding to option 0 described above and an SR (for example, a second SR) corresponding to option 1/2 described above may be configured (see FIG. 7A and FIG. 7B).

FIG. 7A shows a case where a first SR configuration corresponding to option 0 and a second SR configuration corresponding to option 1 are configured for a given cell group. FIG. 7B shows a case where a first SR configuration corresponding to option 0 and a second SR configuration corresponding to option 2 are configured for a given cell group.

For example, one SR (for example, the first SR) may be configured for SCell BFR in Rel. 16, and one SR (for example, the second SR) may be configured for per-TRP BFR in Rel. 17.

A condition for configuration of the two SRs may follow at least one of Alt. 2-1 to Alt. 2-3 below.

### <Alt. 2-1>

For at least one serving cell included in a cell group, configuration of two SRs may be controlled on the basis of whether per-TRP BFR is configured (for example, the presence or absence of the configuration).

When per-TRP BFR is configured for at least one serving cell (for example, an SpCell or an SCell) in the cell group, two SRs may be configured (or two SR configurations may be supported). A first SR (or SR configuration) may be an SR corresponding to option 0 described above, and a second SR (or SR configuration) may be an SR corresponding to option 1/2 described above.

A UE may control so as to transmit the first SR (for example, the SR corresponding to option 0) in a first condition. The first condition may be a case where an SR is triggered by beam failure in two TRPs in an SCell (SCell for which per-TRP BFR is configured) or a case where an SR is triggered by beam failure in an SCell (SCell to which cell-specific BFR is applied).

The UE may control so as to transmit the second SR (for example, the SR corresponding to option 1/2) in a second condition. The second condition may be a case where an SR is triggered by beam failure in one TRP in an SpCell/SCell (SpCell/SCell for which per-TRP BFR is configured). Therefore, SR transmission can be controlled in consideration of a TRP (or a spatial relation/PUCCH resource) in which beam failure has been detected.

### <Alt. 2-2>

Configuration of the first SR and configuration of the second SR may be separately controlled on the basis of different conditions. The different conditions may be a cell type (SpCell/SCell) and a BFR type to be configured/applied (cell-specific BFR/per-TRP BFR). For example, configuration of one SR may be controlled on the basis of whether cell-specific BFR is applied to at least one SCell (for example, the presence or absence of the configuration), and configuration of another SR may be controlled on the basis of whether per-TRP BFR is configured for at least one serving cell (SpCell/SCell) (for example, the presence or absence of the configuration).

When per-TRP BFR is not configured for (or cell-specific BFR is applied to) at least one SCell in the cell group, one SR (for example, a first SR corresponding to option 0) may be configured. When per-TRP BFR is configured for at least one serving cell (for example, an SpCell or an SCell) in the cell group, another SR (for example, a second SR corresponding to option 1/2) may be configured.

When an SR is triggered by beam failure in an SCell (SCell to which cell-specific BFR is applied), the UE may control so as to transmit the first SR (SR corresponding to option 0).

On the other hand, when an SR is triggered by beam failure detection in an SpCell/SCell (SpCell/SCell for which per-TRP BFR is configured), the UE the UE may control so as to transmit the second SR (SR corresponding to option 1/2). Therefore, SR transmission can be controlled in consideration of a TRP (or a spatial relation/PUCCH resource) in which beam failure has been detected.

### <Alt. 2-3>

Configuration of the first SR and configuration of the second SR may be separately controlled on the basis of different conditions. The different conditions may be a cell type (SpCell/SCell) and a BFR type to be configured/applied (cell-specific BFR/per-TRP BFR). For example, configuration of one SR may be controlled on the basis of whether BFR (for example, cell-specific BFR/per-TRP BFR) is applied to at least one SCell (for example, the presence or absence of the configuration), and configuration of another SR may be controlled on the basis of whether per-TRP BFR is configured for an SpCell (for example, the presence or absence of the configuration).

When BFR (for example, per-TRP BFR or cell-specific BFR/BFR in units of a cell) is configured for at least one SCell in the cell group, one SR (for example, a first SR corresponding to option 0) may be configured. Only when per-TRP BFR is configured for the SpCell, another SR (for example, a second SR corresponding to option 1/2) may be configured.

Only when beam failure in one TRP (for example, TRP #0) in the SpCell has been detected, the UE may control so as to transmit the second SR (for example, an SR corresponding to option 1/2). When transmitting the second SR, the UE may use a spatial relation related to another TRP (for example, TRP #1) (option 1), or may use an SR PUCCH/SR PUCCH resource related to another TRP (for example, TRP #1) (option 2).

Otherwise (for example, a case other than a case where beam failure in one TRP in the SpCell has been detected), the UE may control so as to transmit the first SR (for example, an SR corresponding to option 0).

### (UE Capability Information)

In the above-described first aspect to second aspect, a UE capability below may be configured. Note that the UE capability below may be interpreted as a parameter (for example, a higher layer parameter) configured for the UE from a network (for example, the base station).

UE capability information related to whether to support an SR for BFR (for example, per-TRP BFR) for which two PUCCH resources are configured may be defined.

UE capability information related to whether to support a default PUCCH resource for the SR for BFR may be defined.

UE capability information related to whether to support an SR for BFR (for example, per-TRP BFR) for which one PUCCH resource having two spatial relations is configured may be defined.

UE capability information related to whether to support a default spatial relation for the SR for BFR may be defined.

UE capability information related to whether to support an SpCell for which per-TRP BFR is configured may be defined.

UE capability information related to whether to support an SCell for which per-TRP BFR is configured may be defined.

UE capability information related to a maximum number of SCells/serving cells for which per-TRP BFR is configurable in each cell group may be defined.

The first aspect to second aspect may be employed in a UE that supports/reports at least one of the above-mentioned UE capabilities. Alternatively, the first aspect to second aspect may be employed in a UE configured from the network.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

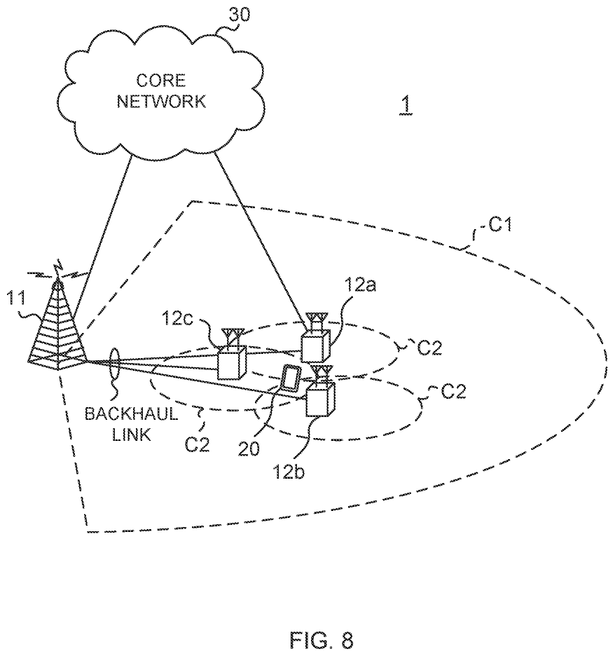

FIG. 8 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a given search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

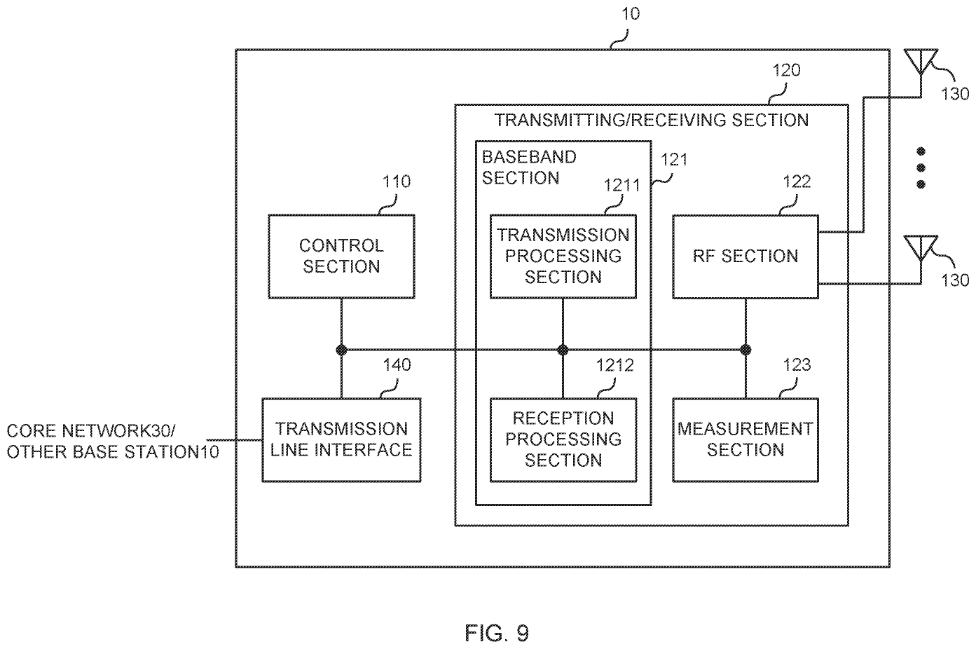

FIG. 9 is a diagram to show an example of a structure of a base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RPUM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit at least one of first information related to configuration of per-transmission/reception point beam failure detection for a specific cell included in a cell group, second information related to configuration of an uplink control channel resource corresponding to a scheduling request configured for the cell group, and third information related to a spatial relation corresponding to the uplink control channel.

The control section 110 may control reception of the scheduling request transmission of which is controlled on the basis of at least one of the first information, the second information, and the third information.

### (User Terminal)

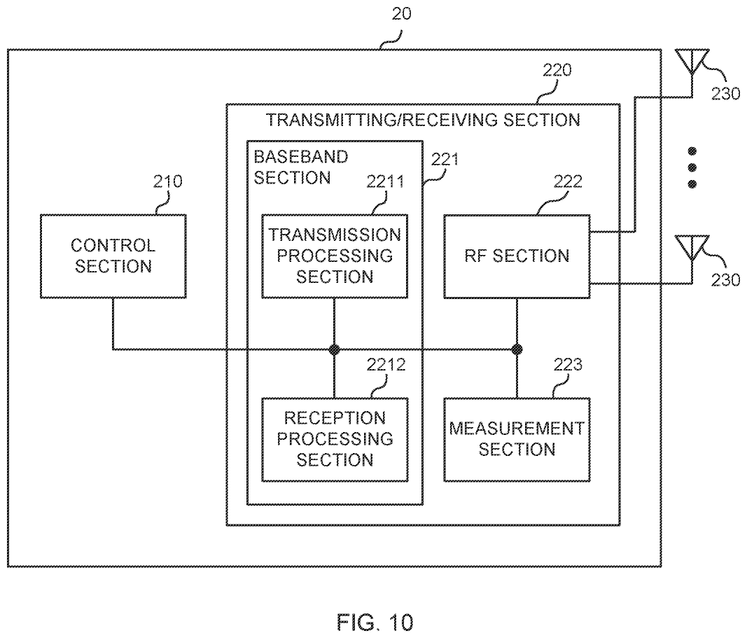

FIG. 10 is a diagram to show an example of a structure of a user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a given channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and receiving section of the user terminal 20 in the present disclosure may be constituted by at least one of the transmitting/receiving section 220 and the transmitting/receiving antennas 230.

The transmitting/receiving section 220 may receive at least one of first information related to configuration of per-transmission/reception point beam failure detection for a specific cell included in a cell group, second information related to configuration of an uplink control channel resource corresponding to a scheduling request configured for the cell group, and third information related to a spatial relation corresponding to an uplink control channel. The transmitting/receiving section 220 may transmit the scheduling request.

The control section 210 may determine, on the basis of at least one of information related to configuration of per-transmission/reception point beam failure detection for a specific cell included in a cell group, information related to configuration of an uplink control channel resource corresponding to a scheduling request configured for the cell group, and information related to a spatial relation corresponding to the uplink control channel, at least one of a spatial relation and an uplink control channel resource used for transmission of the scheduling request.

When per-transmission/reception point beam failure detection is configured for the specific cell, a plurality of spatial relations or a plurality of uplink control channel resources may be configured for a scheduling cell.

When beam failure has been detected in a cell other than the specific cell included in the cell group, the control section 210 may control so as to transmit the scheduling request by using at least one of a default spatial relation and a default uplink control channel resource.

When a plurality of scheduling requests are configured for the cell group, the number of uplink control channel resources corresponding to each scheduling request and the number of spatial relations corresponding to the uplink control channel resources may be separately configured.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate apparatuses (for example, via wire, wireless, or the like) and using these plurality of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

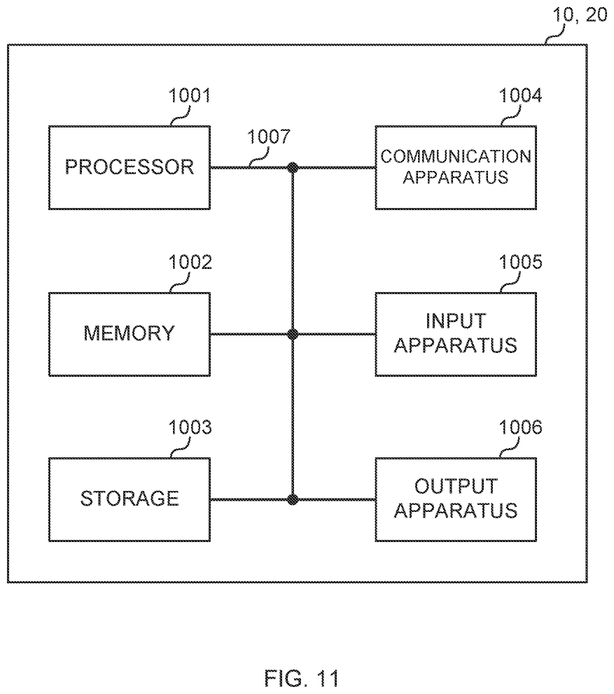

For example, a base station, a user terminal, and so on according to one embodiment of the present disclosure may function as a computer that executes the processes of the radio communication method of the present disclosure. FIG. 11 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing given software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between apparatuses.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a given signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for given numerology in a given carrier. Here, a common RB may be specified by an index of the RB based on the common reference point of the carrier. A PRB may be defined by a given BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a given signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to given values, or may be represented in another corresponding information. For example, radio resources may be specified by given indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. The MAC signaling may be notified by using, for example, media access control control elements (MAC Control Elements (CEs)).

Also, reporting of given information (for example, reporting of “X holds”) does not necessarily have to be reported explicitly, and can be reported implicitly (by, for example, not reporting this given information or reporting another piece of information).

Determinations may be made in values represented by one bit (0 or 1), may be made in Boolean values that represent true or false, or may be made by comparing numerical values (for example, comparison against a given value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms, such as “precoding,” a “precoder,” a “weight (precoding weight),” “quasi-co-location (QCL),” a “Transmission Configuration Indication state (TCI state),” a “spatial relation,” a “spatial domain filter,” “transmission power,” “phase rotation,” an “antenna port,” an “antenna port group,” a “reference signal (Reference Signal (RS) port group),” a “layer,” “the number of layers,” a “rank,” a “resource,” a “resource set,” a “resource group,” a “beam,” a “beam width,” a “beam angular degree,” an “antenna,” an “antenna element,” a “panel,” and a “transmission/reception point” can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a mobile object or a mobile object itself, and so on. The mobile object may be a vehicle (for example, a car, an airplane, and the like), may be a mobile object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “up,” “down,” and the like may be interpreted as the words corresponding to the terminal-to-terminal communication (for example, “side”). For example, an uplink channel, a downlink channel, and the like may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (U4B), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-9. (canceled)

10. A terminal comprising:
a receiver that receives information indicating, for a cell group, configuration of a first scheduling request (SR) for beam failure recovery (BFR) on a secondary cell and configuration of a second SR for BFR per transmission/reception point (TRP); and
a processor that controls to transmit at least one of the first SR and the second SR by using a physical uplink control channel (PUCCH) resource that is determined based on the information.

11. The terminal according to claim 10, further comprising:
a transmitter that transmits capability information related to a number of PUCCH resources available for transmission of the second SR.

12. A radio communication method for a terminal, comprising:
receiving information indicating, for a cell group, configuration of a first scheduling request (SR) for beam failure recovery (BFR) on a secondary cell and configuration of a second SR for BFR per transmission/reception point (TRP); and
controlling to transmit at least one of the first SR and the second SR by using a physical uplink control channel (PUCCH) resource that is determined based on the information.

13. A base station comprising:
a transmitter that transmits information indicating, for a cell group, configuration of a first scheduling request (SR) for beam failure recovery (BFR) on a secondary cell and configuration of a second SR for BFR per transmission/reception point (TRP); and
a processor that controls to receive at least one of the first SR and the second SR by using a physical uplink control channel (PUCCH) resource that is configured based on the information.

14. A system comprising: a terminal; and a base station,
the terminal comprising:
a receiver that receives information indicating, for a cell group, configuration of a first scheduling request (SR) for beam failure recovery (BFR) on a secondary cell and configuration of a second SR for BFR per transmission/reception point (TRP); and
a processor that controls to transmit at least one of the first SR and the second SR by using a physical uplink control channel (PUCCH) resource that is determined based on the information; and
the base station comprising:
a transmitter that transmits the information.
